(19) United States
(12) Patent Application Publication
(10) Pub. No.: US 2018/0310292 A1
(43) Pub. Date: Oct. 25, 2018

(54) LOCAL EDGE CLOUDLET MANAGER, EDGE CLOUDLET SYSTEM AND CONTROLLING METHOD OF EDGE CLOUDLET SYSTEM

(71) Applicant: Industrial Technology Research Institute, Hsinchu (TW)

(72) Inventors: Jen-Shun Yang, Zhubei City (TW); Yi-Huai Hsu, Taoyuan City (TW)

(21) Appl. No.: 15/692,917

(22) Filed: Aug. 31, 2017

(30) Foreign Application Priority Data
Apr. 24, 2017 (TW) 106113670

(51) Int. Cl. H04W 72/04; G06F 9/50; H04L 29/08

(52) U.S. Cl. CPC H04W 72/0406; G06F 9/5083; G06F 9/5072; H04L 67/1004; H04L 67/04

(57) ABSTRACT

A local edge cloudlet manager, an edge cloudlet system and a controlling method of the edge cloudlet system are provided. The edge cloudlet system includes a plurality of small cell APs, a plurality of local edge cloudlet managers (LECMs) and a global edge cloudlet manager (GECM). Each of the LECMs is communicated with some of the small cell APs. The GECM is communicated with the LECMs. The controlling method comprises the following steps: Each of the LECMs transfers an authentication information of a user equipment to the GECM. Each of the LECMs sets a default bearer of the user equipment. Each of the LECMs performs a tracking area update. Each of the LECMs allocates a plurality of computing units of the small cell APs which are communicated with this one of the LECMs.

This application claims the benefit of Taiwan application Serial No. 106113670, filed Apr. 24, 2017, the disclosure of which is incorporated by reference herein in its entirety.

### TECHNICAL FIELD

The disclosure relates in general to a local edge cloudlet manager (LECM), an edge cloudlet system and a controlling method of the edge cloudlet system.

### BACKGROUND

Along with the development of the Internet of Things (IoT), lot of data generated by numerous devices is needed to be uploaded to the cloudlet server, so the bandwidth is congested and the loading of the cloudlet server is heavy. Besides, the Quality of Service (QoS) is varied in different IoT devices. The QoS in each IoT device is not always satisfied due to the bandwidth congestion and the heavy loading. Therefore, an edge cloudlet whose edge device, such as eNB, router or gateway, has computing ability is invented. In the edge cloudlet, the data is not totally uploaded to the cloudlet server, and the edge device can compute some data. As such, the bandwidth congestion can be prevented and the loading of the cloudlet server and the response delay can be lowered to satisfy the QoS of each of the IoT devices.

### SUMMARY

The disclosure is directed to a local edge cloudlet manager, an edge cloudlet system and a controlling method of the edge cloudlet system.

According to one embodiment, a local edge cloudlet manager (LECM) is provided. The LECM includes a local mobility management entity (local MME) and a local resource manager. The local MME is used for transferring an authentication information of a user equipment to a global edge cloudlet manager (GECM), setting a default bearer of the user equipment, or performing a tracking area update. The local resource manager is used for allocating a plurality of computing units of a plurality of small cell APs.

According to another embodiment, an edge cloudlet system is provided. The edge cloudlet system includes a plurality of small cell APs, a plurality of local edge cloudlet managers (LECMs) and a global edge cloudlet manager (GECM). Each of the LECMs is communicated with some of the small cell APs. Each of the LECMs includes a local mobility management entity (local MME) and a local resource manager. The local MME is used for transferring an authentication information of a user equipment to the GECM, setting a default bearer of the user equipment, or performing a tracking area update. The local resource manager is used for allocating a plurality of computing units of some of the small cell APs which are communicated with this one of the LECMs. The GECM is communicated with the LECMs.

According to an alternative embodiment, a controlling method for an edge cloudlet system is provided. The edge cloudlet system includes a plurality of small cell APs, a plurality of local edge cloudlet managers (LECMs) and a global edge cloudlet manager (GECM). Each of the LECMs is communicated with some of the small cell APs. The GECM is communicated with the LECMs. The controlling method comprises the following steps: Each of the LECMs transfers an authentication information of a user equipment to the GECM. Each of the LECMs sets a default bearer of the user equipment. Each of the LECMs performs a tracking area update. Each of the LECMs allocates a plurality of computing units of some of the small cell APs which are communicated with this one of the LECMs.

### BRIEF DESCRIPTION OF THE DRAWINGS

FIG. 1 shows an edge cloudlet system.

FIG. 2 shows a small cell AP according to one embodiment.

FIG. 3 shows a flowchart of a controlling method of an AP filter.

FIG. 4 shows a flowchart of a controlling method of an AP resource monitor.

FIG. 5 shows a flowchart of a controlling method of an application request handler.

FIG. 6 shows a LECM according to one embodiment.

FIG. 7 shows a flowchart of a controlling method of a local filter.

FIG. 8 shows a flowchart of a controlling method of a local resource monitor.

FIG. 9 shows a flowchart of a controlling method of a local resource manager.

FIG. 10 shows a flowchart of a controlling method of a local controller.

FIG. 11 shows a flowchart of a controlling method of a local MME.

FIG. 12 shows a GECM according to one embodiment.

FIG. 13 shows a flowchart of a controlling method of a global filter.

FIG. 14 shows a flowchart of a controlling method of a global resource monitor.

FIG. 15 shows a flowchart of a controlling method of a global resource manager.

FIG. 16 shows a flowchart of a controlling method of a global MME.

FIG. 17 shows the communication of the edge cloudlet system.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

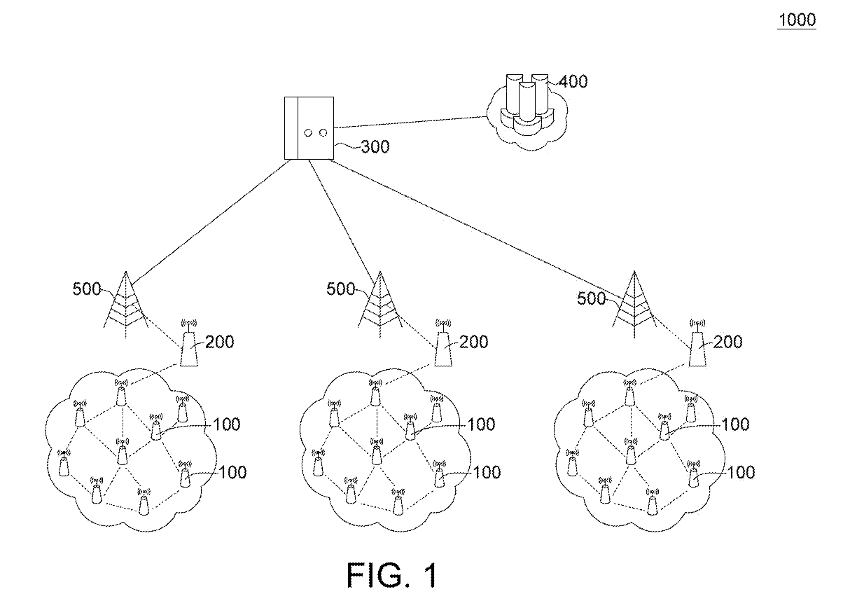

Refer to FIG. 1, which shows an edge cloudlet system 1000. The edge cloudlet system 1000 includes a plurality of small cell APs 100, a plurality of local edge cloudlet managers (LECMs) 200 and a global edge cloudlet manager (GECM) 300. When a user equipment connects to one of the small cell APs 100, the edge cloudlet system 1000 may perform calculation and processing according to an application request.

As shown in FIG. 1, several small cell APs 100 form an Edge Cloudlet via wireless relay. The computing units of each of the Edge Cloudlets are managed by one of the LECMs 200. The LECMs 200 are connected to a base station 500, such as Macro NB, via wireless relay. And, one GECM 300 is setup in an Evolved Packet Core (EPC). The GECM 300 manages the LECMs 200, and handles the computing units served for each of the LECMs 200.

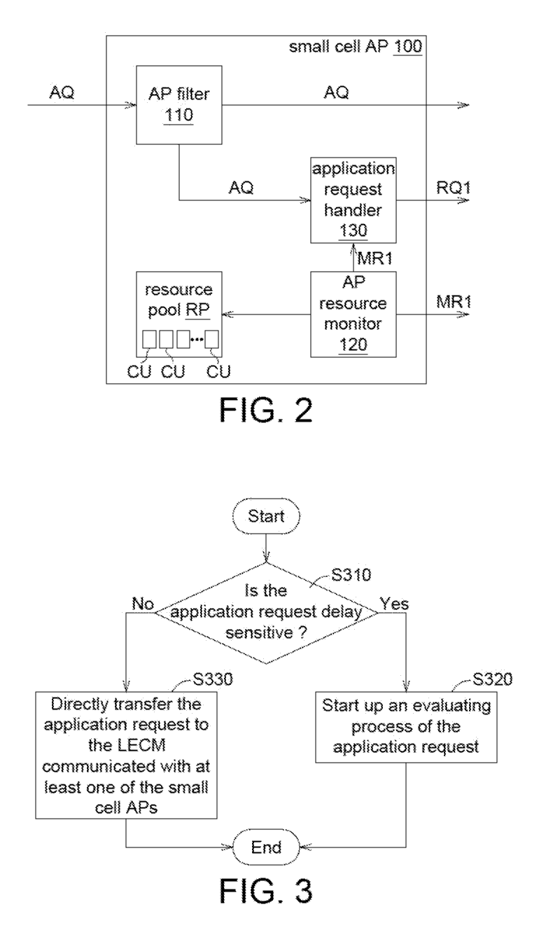

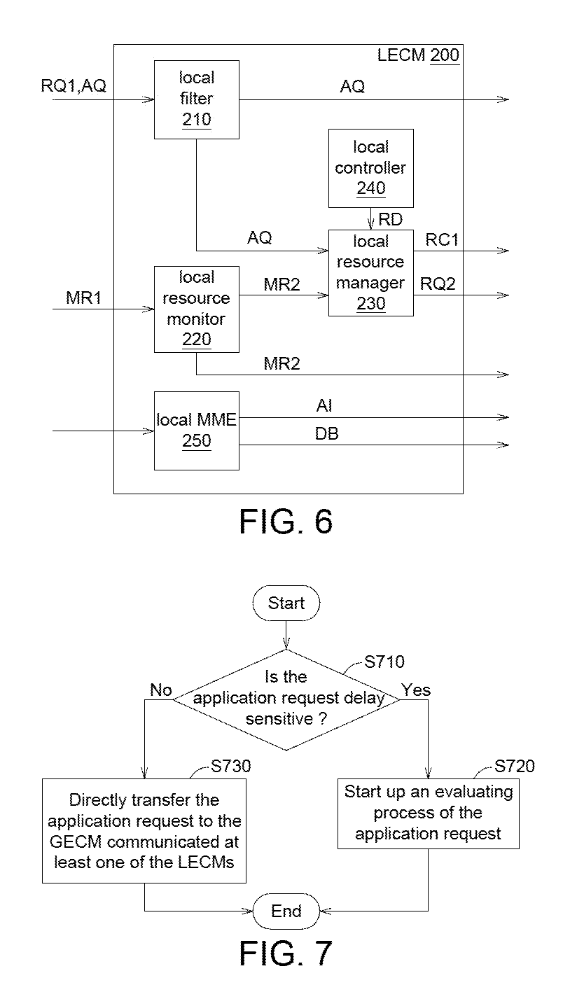

In the present embodiment, each of the LECMs 200 is communicated with some of the small cell APs 100. Each of the LECMs 200 includes a local mobility management entity (local MME) 250 (shown in FIG. 6) and a local resource manager 230 (shown in FIG. 6). The local MME 250 is used for transferring an authentication information of the user equipment to the GECM 300, setting a default bearer DB (shown in FIG. 6) of the user equipment, or performing a tracking area update. The local resource manager 230 is used for allocating a plurality of computing units CU (shown in FIG. 2) of some of the small cell APs 100 which are communicated with one of the LECMs 200. The GECM 300 is communicated with the LECMs 200.

That is to say, a hierarchical management structure is used in the edge cloudlet system 1000 of the present embodiment. One LECM 200 can manage the computing units CU of several small cell APs 100 in single domain. The GECM 300 manages several LECMs 200 to centralize the computing units CU of all the small cell APs 100 managed by the LECMs 200. As such, the computing units CU of the small cell APs 100 can be managed effectively to satisfy the need of different user equipment.

Moreover, in the FIG. 1, some functions of the mobility management entity (MME) which are originally performed by the GECM 300 are assigned to the LECM 200. By using the MME in the LECM 200 with a local gateway (LGW) built in the base station 500 or the LECM 200, the user equipment can directly communicated with the others in the same domain via the local IP access (LIPA) for effectively lowering the network communication delay.

Please refer to FIG. 2, which shows the small cell AP 100 according to one embodiment. The small cell AP 100 includes an AP filter 110, an AP resource monitor 120 and an application request handler 130. For example, the AP filter 110, the AP resource monitor 120, the application request handler 130 or the combination thereof may be a chip, a circuit, a circuit board or a storage device storing a plurality of program codes. The function and operation of each element are described with a flowchart as below.

Please refer to FIG. 3, which show a flowchart of the controlling method of the AP filter 110. In step S310, after the AP filter 110 receives an application request AQ form the user equipment, the AP filter 110 checks whether the application request AQ is delay sensitive or not. One application request AQ may be delay sensitive or delay tolerant. For example, some applications, such as audio and video streaming, augmented reality (AR), virtual reality (VR), which is needed to be immediately processed is delay sensitive. Some application, such as Internet of Things control, which is not needed to be immediately processed is delay tolerant. If the application request AQ is delay sensitive, then this application request AQ is needed to be computed by the edge cloudlet and the process proceeds to step S320; if the application request AQ is delay tolerant, then this application request AQ is not needed to be computed by the edge cloudlet and the process proceeds to step S330.

In step S320, an evaluating process of the application request AQ which is delay sensitive is started up. The evaluating process of the application request AQ is performed by the application request handler 130, and the detail thereof is described below. The evaluating process of the application request AQ is used for evaluating the number of the computing units CU needed to be allocated for this application request AQ.

In step S330, the AP filter 110 directly transfers the application request AQ which is delay tolerant to the LECM 200 communicated with at least one of the small cell APs 100.

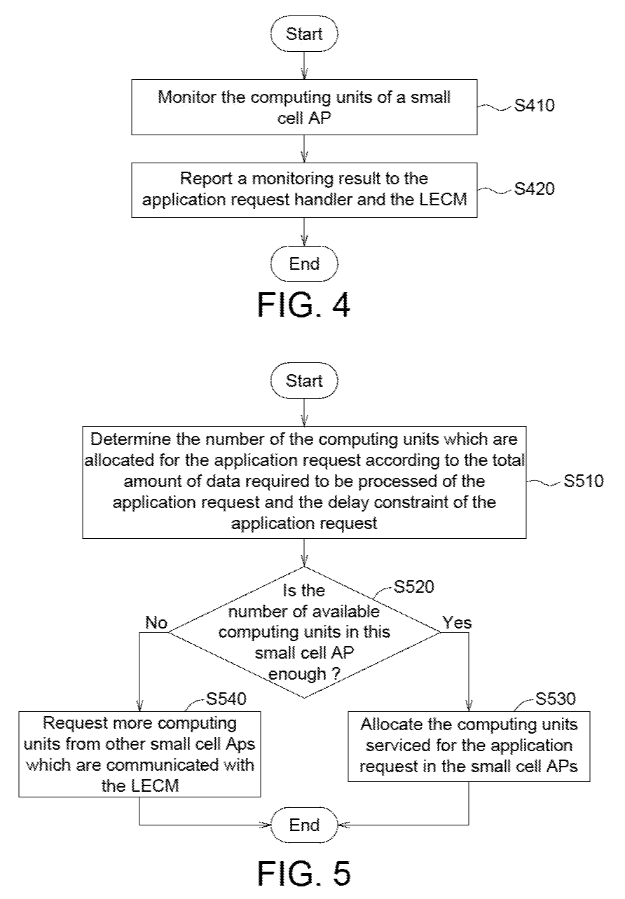

Please refer to FIG. 4, which shows a flowchart of a controlling method of the AP resource monitor 120. In step S410, the AP resource monitor 120 monitors the computing units of a small cell AP 100. As shown in FIG. 2, the computing units CU are located in a resource pool RP. The resource pool RP can be an internal element of the small cell AP 100, or an external element of the small cell AP 100.

In step S420, the AP resource monitor 120 reports a monitoring result MR1 to the application request handler 130 and the LECM 200.

Please refer to FIG. 5, which shows a flowchart of a controlling method of the application request handler 130. Firstly, please refer to the following equation (1):

$$\frac{{D}_{j}}{{N}_{req - j} \times C} < {d}_{c - j} \qquad ( 1 )$$

Dⱼ is total amount of data required to be processed of the j-th application request AQ.

N_{req-j} is the number of computing units CU required for the j-th application request AQ.

C is the computing ability (bits/sec) of the computing unit CU.

d_{c-j} is the delay constraint of the j-th application request AQ.

The equation (1) can be deduced to be the following equation (2):

$${N}_{req - j} > \frac{{D}_{j}}{C \times {d}_{c - j}} \qquad ( 2 )$$

In step S510, the application request handler 130 determines the number of the computing units CU which are allocated for the application request AQ (i.e. N_{req-j}) according to the total amount of data required to be processed of the application request AQ (i.e. Dⱼ) and the delay constraint of the application request AQ (i.e. d_{c-j}).

When the i-th small cell AP 100 of the k-th LECM 200 receives the j-th application request AQ, the computing units CU can be allocated to serve the j-th application request AQ according to the following algorithm:

```
if(N_{used-eNB-i} + N_{req-j} < N_{total-eNB})
  N_{used-eNB-i} = N_{used-eNB-i} + N_{req-j}
else
  N_{add-j} = N_{used-eNB-i} + N_{req-j} − N_{total-eNB}
  N_{used-eNB-i} = N_{total-eNB}
end if
```

N_{used-eNB-i} is the number of the computing units CU used in the i-th small cell AP 100.

N_{total-eNB} is the total number of the computing units CU available for one small cell AP 100.

N_{add-j} is the additional number of the computing units CU needed to process the j-th application request.

That is to say, in step S520, the application request handler 130 determines whether the number of available computing units CU in this small cell AP 100 is enough or not. If the number of the computing units CU in this small cell AP 100 is enough, then the process proceeds to step S530; if the number of the computing units CU in this small cell AP 100 is not enough, then the process proceeds to step S540.

In step S530, the application request handler 130 allocates the computing units CU serviced for the application request in the small cell APs 100.

In step S540, the application request handler 130 sends a resource request RQ1 to the LECM 200 for requesting more computing units CU from other small cell APs 100 which are communicated with the LECM 200.

Please refer to FIG. 6, which shows the LECM 200 according to one embodiment. The LECM 200 includes a local filter 210, a local resource monitor 220, a local resource manager 230, a local controller 240 and a local MME 250. For example, the local filter 210, the local resource monitor 220, the local resource manager 230, the local controller 240, the local MME 250 or the combination thereof may be a chip, a circuit, a circuit board or a storage device storing a plurality of program codes. The function and operation of each element are described with a flowchart as below.

Please refer to FIG. 7, which shows a flowchart of a controlling method of the local filter 210. In step S710, after the local filter 210 receives the application request AQ from the small cell AP 100, the local filter 210 checks whether the application request AQ is delay sensitive or not. If the application request AQ is delay sensitive, then this application request AQ is needed to be computed by the edge cloudlet and the process proceeds to step S720; if the application request AQ is delay tolerant, then this application request AQ is not needed to be computed by the edge cloudlet and the process proceeds to step S730.

In step S720, an evaluating process of the application request AQ which is delay sensitive is started up. The evaluating process of the application request AQ is performed by the local resource manager 230, and the detail thereof is described below. The evaluating process of the application request AQ is used for allocating the computing units CU for this application request AQ between at least one of the small cell APs 100 which are communicated with the LECM 200.

In step S730, the local filter 210 directly transfers the application request AQ which is delay tolerant to the GECM 300 communicated with at least one of the LECMs 200.

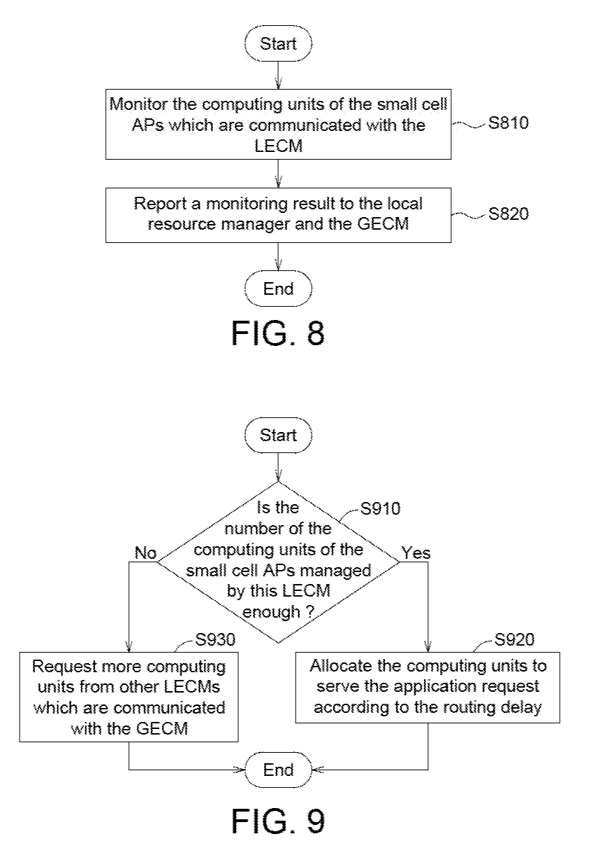

Please refer to FIG. 8, which shows a flowchart of a controlling method of the local resource monitor 220. In step S810, the local resource monitor 220 monitors the computing units CU of the small cell APs 100 which are communicated with the LECM 200.

Next, in step S820, the local resource monitor 220 reports a monitoring result MR2 to the local resource manager 230 and the GECM 300.

Please refer to FIG. 9, which shows a flowchart of a controlling method of the local resource manager 230. When the k-th LECM 200 receives the j-th application request AQ from the i-th small cell AP 100 or the GECM 300 and the number of the computing units CU of the small cell APs 100 managed by the k-th LECM 200 is enough, the small cell APs 100 communicated with this LECM 200 will be sorted according to the routing delays RD in ascending order. Then the computing units CU of those small cell APs 100 can be allocated to serve the j-th application request AQ according to the following algorithm:

```
if (N_{add-j} ! = 0 && N_{used-eNB-n} < N_{total-eNB})
  if(N_{add-j} < (N_{total-eNB} − N_{used-eNB-n}))
    N_{used-eNB-n} = N_{used-eNB-n} + N_{add-j}
    N_{add-j} = 0
  else
    N_{used-eNB-n} = N_{total-eNB}
    N_{add-j} = N_{add-j} − (N_{total-eNB} − N_{used-eNB-n})
  end if
end if
```

N_{used-eNB-n} is the number of the computing units CU used in the n-th small cell AP 100.

That is to say, in step S910, the local resource manager 230 checks whether the number of the computing units CU of the small cell APs 100 managed by this LECM 200 is enough or not. If the number of the computing units CU of the small cell APs 100 managed by this LECM 200 is enough, then the process proceeds to step S920; if the number of the computing units CU of the small cell APs 100 managed by this LECM 200 is not enough, then the process proceeds to step S930.

In step S920, the local resource manager 230 sends an allocating command RC1 to at least one of the small cell APs 100 communicated with this LECM 200 to allocate the computing units CU to serve the application request AQ according to the routing delay RD.

In step S930, the local resource manager 230 sends a resource request RQ2 to the GECM 300 for requesting more computing units CU from other LECMs 200 which are communicated with the GECM 300.

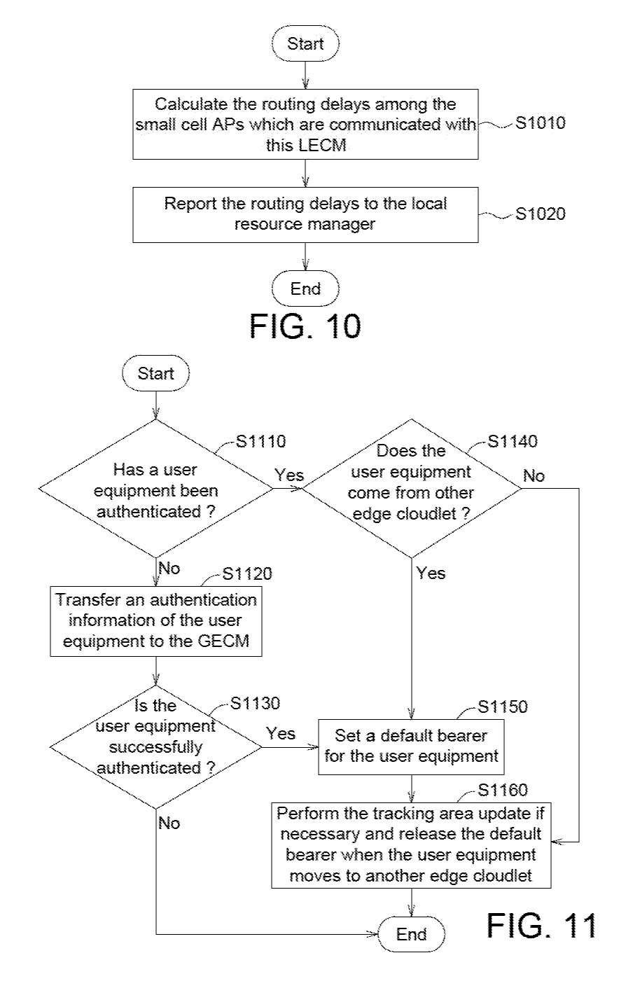

Please refer to FIG. 10, which shows a flowchart of a controlling method of the local controller 240. The routing delay RD can be calculated by the local controller 240. In step S1010, the local controller 240 calculates the routing delays RD among the small cell APs 100 which are communicated with this LECM 200.

Next, in step S1020, the routing delays RD are reported to the local resource manager 230, for allocating the computing units CU.

Please refer to FIG. 11, which shows a flowchart of a controlling method of the local MME 250. In this embodiment, some functions of the MME which are originally performed by the GECM 300 are assigned to the LECM 200. As shown in FIG. 11, in step S1110, the local MME 250 checks whether a user equipment has been authenticated or not. If the user equipment has not been authenticated, then the process proceeds to step S1120, if the user equipment has been authenticated, then the process proceeds to step S1140.

In step S1120, the local MME 250 transfers an authentication information AI of the user equipment to the GECM 300.

In step S1130, the local MME 250 checks whether the user equipment is successfully authenticated or not. If the user equipment is successfully authenticated, then the process proceeds to step S1150; if the user equipment is not successfully authenticated, the process is terminated.

In step S1140, the local MME 250 checks whether the user equipment comes from other edge cloudlet. If the user equipment comes from other edge cloudlet, then the process proceeds to step S1150; if the user equipment does not come from other edge cloudlet, then the process proceeds to the step S1160.

In step S1150, the local MME 250 sets a default bearer DB for the user equipment.

In step S1160, the local MME 250 performs the tracking area update if necessary and releases the default bearer DB when the user equipment moves to another edge cloudlet.

The LECM 200 may perform some functions of the MME. By using the MME in the LECM 200 with the local gateway (LGW), the user equipment can directly communicated with the others in the same domain via the local IP access (LIPA) for effectively lowering the network communication delay.

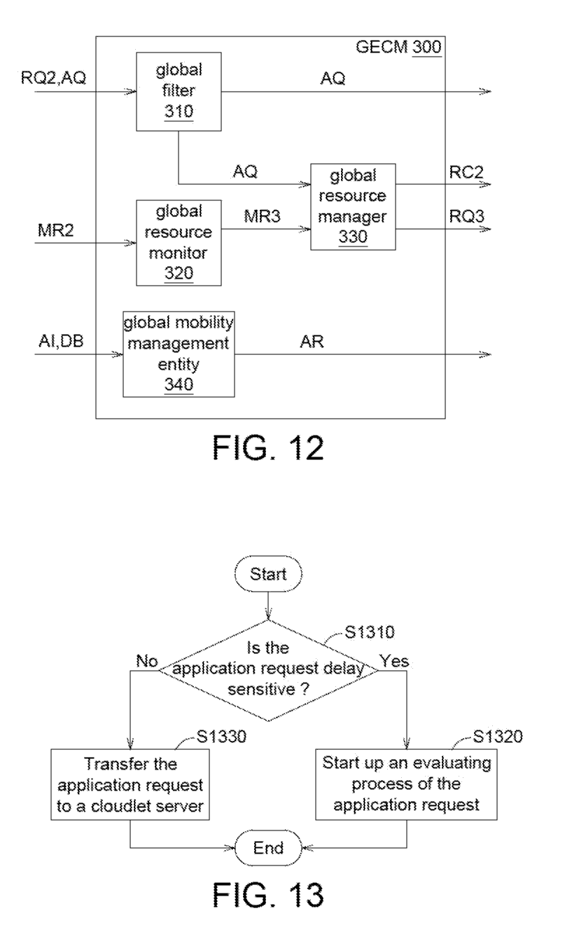

Please refer to FIG. 12, which shows the GECM 300 according to one embodiment. The GECM 300 includes a global filter 310, a global resource monitor 320, a global resource manager 330 and a global mobility management entity (global MME) 340. For example, the global filter 310, the global resource monitor 320, the global resource manager 330, the global MME 340 or the combination thereof may be a chip, a circuit, a circuit board or a storage device storing a plurality of program codes. The function and operation of each element are described with a flowchart as below.

Please refer to FIG. 13, which shows a flowchart of a controlling method of the global filter 310. In step S1310, after the global filter 310 receives the application request AQ from the LECM 200, the global filter 310 checks whether the application request AQ is delay sensitive or not. If the application request AQ is delay sensitive, then this application request AQ is needed to be computed immediately and the process proceeds to step S1320, if the application request AQ is delay tolerant, then this application request AQ is not needed to be computed immediately and the process proceeds to step S1330.

In step S1320, an evaluating process of the application request AQ which is delay sensitive is started up. The evaluating process of the application request AQ is performed by the global resource manager 330, and the detail thereof is described below. The evaluating process of the application request AQ is used for allocating the computing units CU for this application request AQ between at least one of the LECMs 200 which are communicated with the GECM 300.

In step S1330, the global filter 310 transfers the application request AQ to a cloudlet server 400.

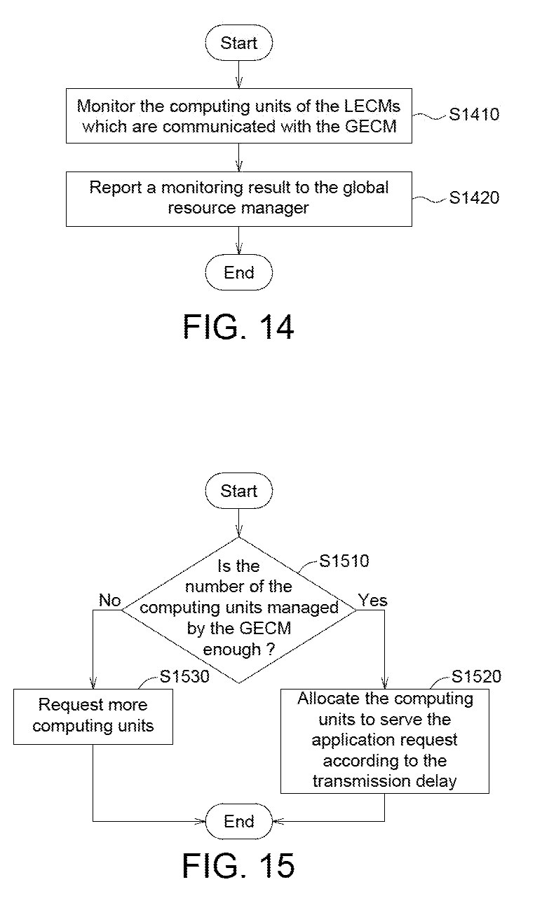

Please refer to FIG. 14, which shows a flowchart of a controlling method of the global resource monitor 320. In step S1410, the global resource monitor 320 monitors the computing units CU of the LECMs 200 which are communicated with the GECM 300.

In step S1420, the global resource monitor 320 reports a monitoring result MR3 to the global resource manager 330.

Please refer to FIG. 15, which shows a flowchart of a controlling method of the global resource manager 330. When the GECM 300 receives the j-th application request AQ from the k-th LECM 200 and the number of the computing units CU managed by the GECM 300 is enough, the LECMs 200 communicated with the GECM 300 will be sorted according to the transmission delay, and the computing units CU managed by those LECMs 200 can be allocated according to the following algorithm:

```
if (N_{add-j} ! = 0 && N_{used-LECM-m} < N_{total-LECM-m})
  if(N_{add-j} < (N_{total-LECM-m} − N_{used-LECM-m}))
    N_{used-LECM-m} = N_{used-LECM-m} + N_{add-j}
    N_{add-j} = 0
  else
    N_{used-LECM-m} = N_{total-LECM-m}
    N_{add-j} = N_{add-j} − (N_{total-LECM-m} − N_{used-LECM-m})
  end if
end if
```

N_{total-LECM-m} is the total number of the computing units CU available for the m-th LECM 200. N_{used-LECM-m} is the number of the computing units CU used in the m-th LECM 200.

That is to say, in step S1510, the global resource manager 330 checks whether the number of the computing units CU managed by the GECM 300 is enough or not. If the number of the computing units CU managed by the GECM 300 is enough, then the process proceeds to step S1520; if the number of the computing units CU managed by the GECM 300 is not enough, then the process proceeds to step S1530.

In step S1520, the global resource manager 330 sends an allocating command RC2 to at least one of the LECMs 200 communicated with this GECM 300 to allocate the computing units CU to serve the application request AQ according to the transmission delay.

In step S1530, the global resource manager 330 sends a resource request RQ3 to the cloudlet server 400 for requesting more computing units CU.

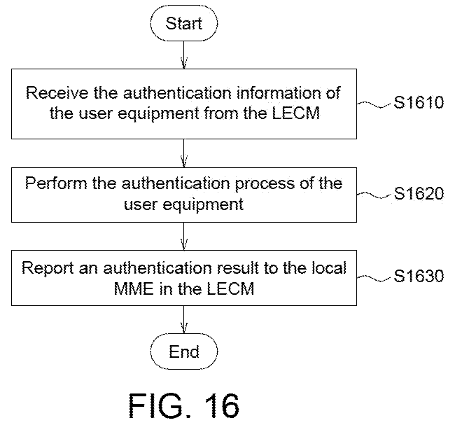

Please refer to FIG. 16, which shows a flowchart of a controlling method of the global MME 340. In step S1610, the global MME 340 receives the authentication information AI of the user equipment from the LECM 200.

In step S1620, the global MME 340 performs the authentication process of the user equipment.

In step S1630, the global MME 340 reports an authentication result AR to the local MME 250 in the LECM 200.

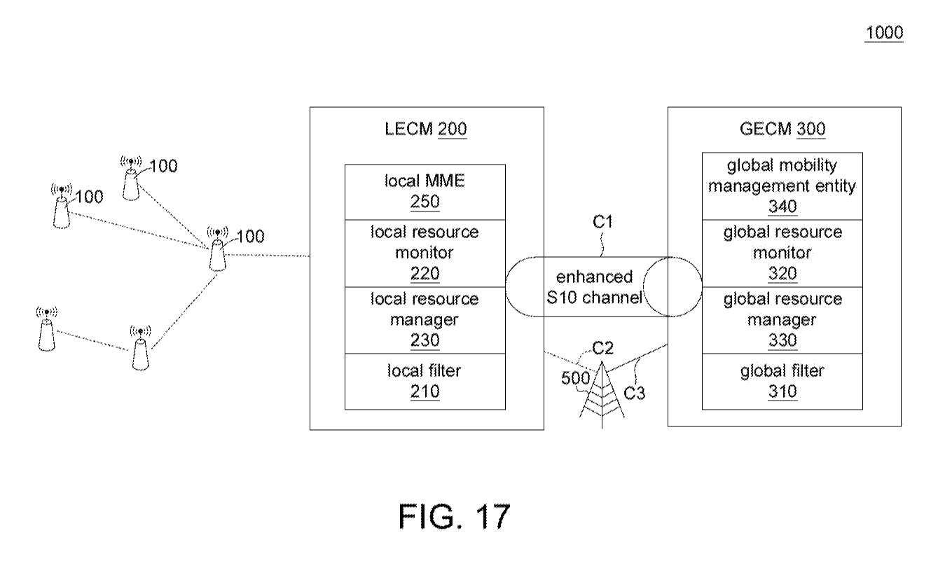

Please refer to FIG. 17, which shows the wireless communication of the edge cloudlet system 1000. In the present embodiment, the LECM 200 and the GECM 300 are communicated via an enhanced S10 interface C1. The base station 500 and the LECM 200 are communicated via a Uu interface C2. The base station 500 and the GECM 300 are communicated via a S1 interface C3.

The hierarchical management structure is used in the edge cloudlet system 1000 of the present embodiment. One LECM 200 may manage the computing units CU of several small cell APs 100 in single domain. The GECM 300 manages several LECMs 200 to centralize the computing units CU of all the small cell APs 100 managed by the LECMs 200. As such, the computing units CU of the small cell APs 100 can be managed effectively to satisfy the need of different user equipment.

Moreover, some functions of the MME which are originally performed by the GECM 300 are assigned to the LECMs 200. By using the MME in the LECM 200 with the local gateway (LGW) built in the base station 500 or the LECM 200, the user equipment can directly communicated with the others in the same domain via the local IP access (LIPA) for effectively lowering the network communication delay.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A local edge cloudlet manager (LECM), comprising:
a local mobility management entity (local MME), used for transferring an authentication information of a user equipment to a global edge cloudlet manager (GECM), setting a default bearer of the user equipment, or performing a tracking area update; and
a local resource manager, for allocating a plurality of computing units of a plurality of small cell APs.

2. The LECM according to claim 1, wherein the local resource manager allocates the computing units according to a plurality of routing delays of the small cell APs.

3. The LECM according to claim 2, further comprising:
a local controller, used for calculating the routing delays of the small cell APs.

4. The LECM according to claim 1, further comprising:
a local resource monitor, used for monitoring the computing units of the small cell APs.

5. An edge cloudlet system, comprising:
a plurality of small cell APs;
a plurality of local edge cloudlet managers (LECMs), wherein each of the LECMs is communicated with some of the small cell APs, and each of the LECMs includes:
a local mobility management entity (local MME), used for transferring an authentication information of a user equipment to a global edge cloudlet manager (GECM), setting a default bearer of the user equipment, or performing a tracking area update; and
a local resource manager, used for allocating a plurality of computing units of some of the small cell APs which are communicated with this one of the LECMs, and
the GECM, communicated with the LECMs.

6. The edge cloudlet system according to claim 5, wherein each of the local resource managers allocates the computing units according to a plurality of routing delays of some of the small cell APs which are communicated with this one of the LECMs.

7. The edge cloudlet system according to claim 6, wherein each of the LECMs further comprises:
a local controller, used for calculating the routing delays of some of the small cell APs which are communicated with this one of the LECMs.

8. The edge cloudlet system according to claim 5, wherein each of the LECMs further comprises:
a local resource monitor, used for monitoring the computing units of the small cell APs which are communicated with this one of the LECMs.

9. The edge cloudlet system according to claim 5, wherein each of the small cell APs comprises:
an application request handler, used for allocating the computing units serviced in this one of the small cell APs, or requesting other computing unit from others of the small cell APs which are communicated with one of the LECMs.

10. The edge cloudlet system according to claim 5, wherein each of the small cell Aps comprises:
an AP resource monitor, used for monitoring the computing units of this one of the small cell APs.

11. The edge cloudlet system according to claim 5, wherein the GECM comprises:
a global mobility management entity (global MME), used for receiving the authentication information of the user equipment from the LECMs, and for performing an authentication process of the user equipment.

12. The edge cloudlet system according to claim 5, wherein the GECM comprises:
a global resource monitor, used for monitoring the computing units of the LECMs.

13. The edge cloudlet system according to claim 5, wherein the GECM comprises:
a global resource manager, used for allocating the computing units to the LECMs which are communicated with the GECM.

14. The edge cloudlet system according to claim 13, wherein the global resource manager allocates the computing units according to a plurality of transmission delays of the LECMs which are communicated with the GECM.

15. A controlling method for an edge cloudlet system, wherein the edge cloudlet system includes a plurality of small cell APs, a plurality of local edge cloudlet managers (LECMs) and a global edge cloudlet manager (GECM), each of the LECMs is communicated with some of the small cell APs, the GECM is communicated with the LECMs, and controlling method comprises:
transferring, by each of the LECMs, an authentication information of a user equipment to the GECM;
setting, by each of the LECMs, a default bearer of the user equipment;
performing, by each of the LECMs, a tracking area update; and
allocating, by each of the LECMs, a plurality of computing units of some of the small cell APs which are communicated with this one of the LECMs.

16. The controlling method for the edge cloudlet system according to claim 15, wherein each of the local resource managers allocates the computing units according to a plurality of routing delays of the small cell APs which are communicated with this one of the LECMs.

17. The controlling method for the edge cloudlet system according to claim 16, further comprising:
calculating, by each of the LECMs, the routing delays of the small cell APs which are communicated with this one of the LECMs.

18. The controlling method for the edge cloudlet system according to claim 15, further comprising:
monitoring, by each of the LECMs, the computing units of the small cell APs which are communicated with this one of the LECMs.

19. The controlling method for the edge cloudlet system according to claim 15, further comprising:
allocating, by each of the small cell APs, the computing units serviced in this one of the small cell APs, or requesting, by each of the small cell APs, other computing unit from others of the small cell APs which are communicated with one of the LECMs.

20. The controlling method for the edge cloudlet system according to claim 15, further comprising:
monitoring, by each of the small cell APs, the computing units of this one of the small cell APs.

21. The controlling method for the edge cloudlet system according to claim 15, further comprising:
receiving, by the GECM, the authentication information of the user equipment from the LECMs, and performing, by the GECM, an authentication process of the user equipment.

22. The controlling method for the edge cloudlet system according to claim 15, further comprising:
monitoring, by the GECM, the computing units of the LECMs.

23. The controlling method for the edge cloudlet system according to claim 15, further comprising:
allocating, by the GECM, the computing units to some of the LECMs which are communicated with the GECM.

24. The controlling method for the edge cloudlet system according to claim 15, wherein the GECM allocates the computing units according to a plurality of transmission delays of some of the LECMs which are communicated with the GECM.
